(19) United States
(12) Patent Application Publication
(10) Pub. No.: US 2022/0169438 A1
(43) Pub. Date: Jun. 2, 2022

(54) CAPSULE FOR INFUSION PRODUCTS

(71) Applicant: ESSSE CAFFE' S.P.A., Bologna (IT)

(72) Inventors: ROBERTO BONANNO, Bologna (IT); MAURIZIO BARBI, Bologna (IT)

(21) Appl. No.: 17/598,938

(22) PCT Filed: Apr. 1, 2020
(86) PCT No.: PCT/IB2020/053099

§ 371 Date: Sep. 28, 2021

(30) Foreign Application Priority Data
Apr. 1, 2019 (IT) 102019000004847

(51) Int. Cl. B65D 85/804

(52) U.S. Cl. CPC B65D 85/8043; A47J 31/407

(57) ABSTRACT

A capsule for infusion products with a cup-shaped body with a longitudinal axis, a bottom and a lateral wall, which delimit an inner housing to house a product for infusion and an opening for putting said inner housing in communication with the external environment; the cup-shaped body having a collar which protrudes outside of said lateral wall at said opening; the capsule having a lid which is connected to said collar and closes said opening; the capsule having a variable thickness along said collar.

### CROSS-REFERENCE TO RELATED APPLICATIONS

This application is the U.S. National Stage of PCT Application No. PCT/IB2020/053099 filed on 1 Apr. 2020, which claims priority from Italian Patent Application No. 102019000004847 filed on Apr. 1, 2019.

### TECHNICAL FIELD

The present invention relates to a capsule for containing infusion products. In particular, the present invention relates to a capsule for containing granular products, in leaves or powder form such as coffee, barley, milk powder, tea, chamomile, etc.

### BACKGROUND ART

As is known, a capsule for infusion products currently on the market comprises a cup-shaped body having a brewing chamber accessible from the outside through an opening made in the cup-shaped body itself.

This opening is generally closed by a lid, so as to seal the infusion product inside the capsule. A capsule of a known type also has a dispensing outlet, which sets the brewing chamber in communication with the external environment, and comprises a filter arranged inside the brewing chamber in proximity of the outlet, so as to filter the beverage before dispensing to the outside.

A capsule of a known type has, furthermore, a collar, which protrudes radially outside the cup-shaped body at the opening and is used as an abutment surface for fastening the lid to the cup-shaped body itself.

In use, the capsule is inserted into a percolation chamber of a beverage extraction machine.

Hot pressurized water is injected into the brewing chamber through the lid, by forming holes or by using pre-existing through-holes on the lid. In this way, the water mixes with the infusion product and flows out of the capsule through the dispensing outlet. The filter allows to keep the infusion product inside the brewing chamber, so as not to be distributed to the outside along with the beverage.

A capsule of the known type described above has several drawbacks. Generally, the cup-shaped body and the collar are made in a single piece and are made of plastic by means of moulding.

The thickness of the collar in the capsules of a known type is generally more than 3 mm. However, this thickness of the collar is oversized compared to its technical functionality. In fact, keeping the lid firmly on the cup-shaped body, it mainly depends on the extension of the contact surface with the lid itself, while the thickness of the collar does not have a significant impact on the cohesion and stability of the capsule.

However, simply reducing the thickness of the entire collar could cause compatibility problems with machines for extracting beverages that are already on the market. In fact, a lesser thickness of the collar inevitably complicates the clearances with the capsule guide systems already provided on the machines for extracting beverages. In fact, generally a capsule, once inserted into a machine for dispensing beverages, follows a path until it is positioned inside a percolation chamber and, once used, follows an additional path to be inserted in a waste tank.

Generally, the guides of the capsule are arranged along said paths which engage with the collar.

Therefore, the presence of clearances between the collar and the guides can cause jamming or incorrect positioning of the capsule inside the percolation chamber, with consequent improper (or failure) dispensing of the beverage.

### DISCLOSURE OF INVENTION

The aim of the present invention is to provide a capsule for infusion products which overcomes the problems described above.

The aim of the present invention is to provide a capsule that allows to reduce the consumption of plastic and, consequently, to reduce the cost and the polluting impact of a capsule and, at the same time, that can be used in existing machines for extracting beverages without the risk of jamming or malfunctions.

According to the present invention a capsule is provided as mentioned in the attached claims.

### BRIEF DESCRIPTION OF THE DRAWINGS

The present invention will now be described with reference to the attached drawings, which illustrate non-limiting examples of embodiments thereof, wherein:

FIGS. 1 and 2 are perspective and schematic views of a capsule for infusion products according to the present invention;

FIG. 3 is a bottom view of the capsule of FIG. 1;

FIG. 4 is a perspective view of an alternative of the capsule of FIG. 1;

FIG. 5 is a bottom view of FIG. 4;

FIG. 6 is a perspective view of a further alternative of FIG. 1;

FIG. 7 is a bottom view of the capsule of FIG. 6;

FIG. 8 is a perspective view of a further embodiment of a capsule according to the present invention;

FIG. 9 is a bottom view of the capsule of FIG. 8;

FIG. 10 is a perspective view of an alternative of the capsule of FIG. 8; and,

FIG. 11 is a perspective view of a further alternative of the capsule of FIG. 8.

### PREFERRED EMBODIMENTS OF THE INVENTION

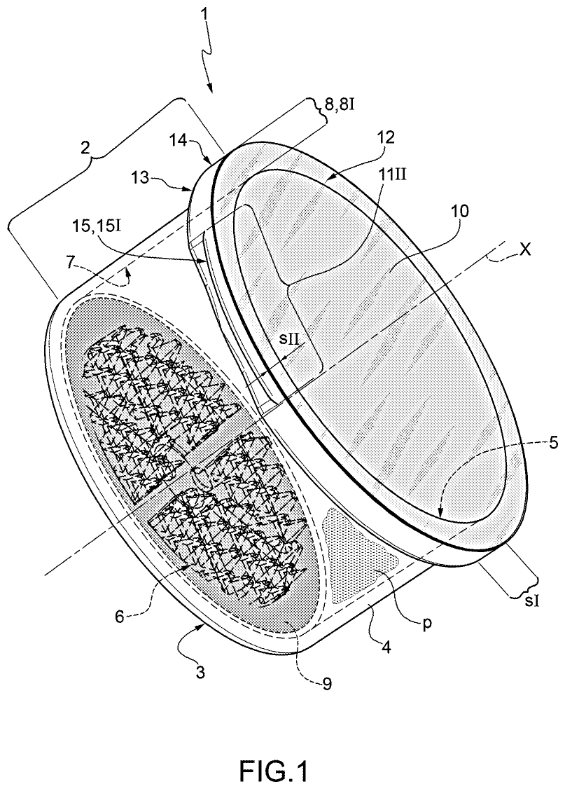

In FIG. 1, number 1 denotes as a whole a capsule 1 for infusion products according to the present invention. The capsule 1 comprises a cup-shaped body 2 with a longitudinal axis X, a bottom 3 and a lateral wall 4. The lateral wall protrudes from the bottom 3 parallel to the longitudinal axis X.

The cup-shaped body 2 has, furthermore: an opening 5; a dispensing outlet 6; and a brewing chamber 7, which is in communication with the external environment both through the opening 5 and through the dispensing outlet 6. According to the illustrated example, the perimeter of the opening 5 is delimited by the lateral wall 4 itself. According to the illustrated example, the dispensing outlet 6 is made through the bottom 3.

According to the illustrated example, the cup-shaped body 2 has a circular section. According to the alternatives not illustrated, the cup-shaped body 2 can have sections of different shapes, for example it can be polygonal.

The cup-shaped body 2 comprises, furthermore, a collar 8 which protrudes outside the lateral wall 4. According to the illustrated example, the collar 8 is substantially a circular crown, which surrounds the lateral wall 4. According to alternatives not illustrated, the collar 8 can have different shapes. For example, in the case of a cup-shaped body 2 with a polygonal section, the collar 8 can have a polygonal shape similar to that of the lateral wall.

The capsule 1 further comprises a filter 9 housed inside the brewing chamber 7 and which at least partially covers the dispensing outlet 6. The capsule 1 comprises, furthermore, a lid 10 which is fastened to the collar 8, so as to close the infusion product p inside the brewing chamber 7.

In particular, the collar 8 has an upper surface 12, which is configured to be at least partially placed in contact with the lid 10, a lower surface 13 substantially opposite the upper surface 12 and a lateral surface 14.

According to the present invention, the thickness of the capsule 1 is different at the respective different areas of the collar 8. With thickness, we mean the extension along the axis X.

The terms top, bottom, upper, lower and the like are used with reference to the longitudinal axis X when the capsule is resting with bottom 3 on a support surface.

Advantageously, the capsule 1 comprises one or more variation means 15, each of which is configured to vary the thickness s of the collar 8 at a respective portion 1I.

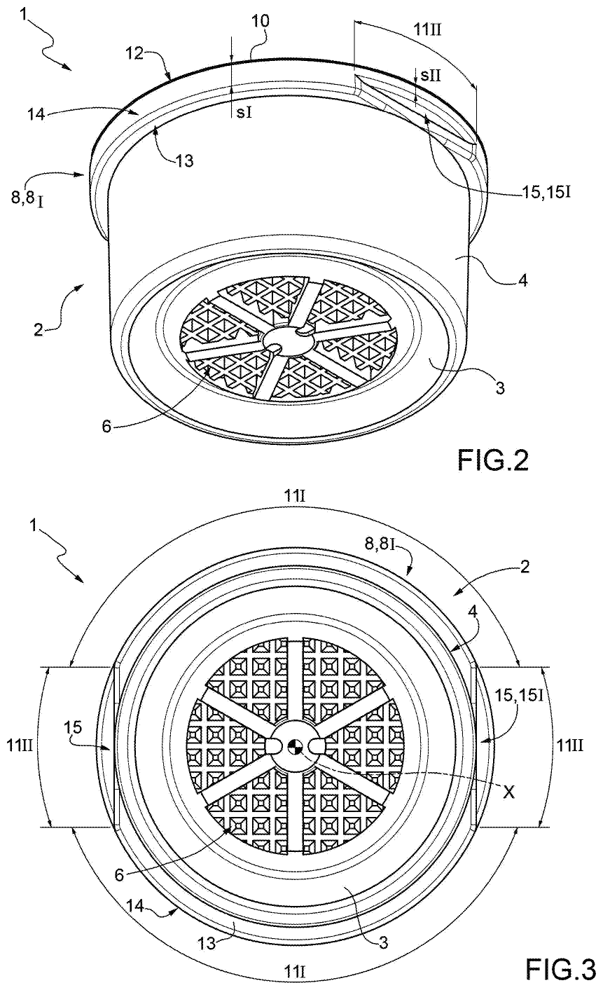

According to the embodiments illustrated in FIGS. 1 to 7, the variation means 15 are grooves 15I, i.e. indentations, which locally reduce the thickness of the collar 8.

According to the examples illustrated in FIGS. 1 to 7, the collar 8I has one or more portions 11I with thickness sI and one or more portions 11II with thickness sII. In other words, the collar 8I has a variable thickness. The thickness sII is less than the thickness sI.

According to the example illustrated in FIGS. 1 to 7, the collar 8I has a thickness sI, which substantially corresponds to the standard thickness of the collar of a capsule of a known type. Generally, the standard thickness s for the collar of a capsule is comprised between 3 and 6 mm.

Advantageously, the fact that the collar 8I has at least a bottom portion 11I with a substantially standard thickness sI allows to use the capsule 1 also with pre-existing machines for preparing beverages, without the risk of jamming or malfunctions.

Preferably, each portion 11I has a thickness sII comprised between 0.5 and 2 mm.

According to the example illustrated in FIGS. 1 to 3, the collar 8I has a pair of grooves 15I parallel and opposite to one another with respect to the lateral wall 4.

In FIGS. 5 to 7 with 101 and 201, respectively, two alternatives of the capsule 1 illustrated in FIGS. 1 to 3 are denoted.

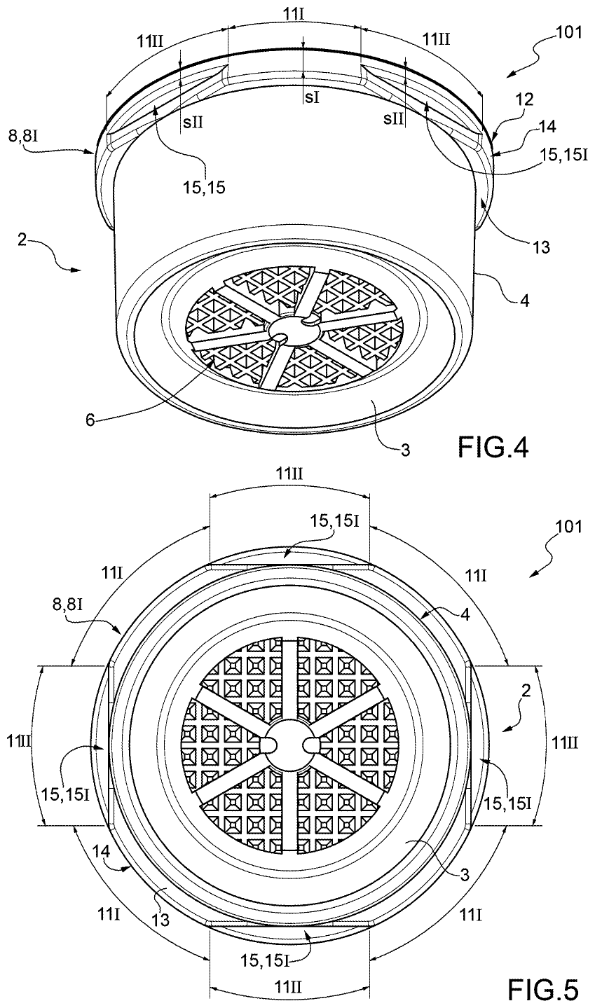

FIGS. 4 to 7 show examples of alternatives of the capsule 1 illustrated in FIGS. 1 to 3.

In the examples illustrated in FIGS. 4 to 7, the elements in common with the capsule 1 maintain the same numeration and are considered included therein, without re-numbering them for the sake of brevity.

According to the example illustrated in FIGS. 4 and 5, the capsule 101 has four grooves 15I. In particular, the capsule 101 has two pairs of grooves parallel and opposite to one another. In the illustrated example, the pairs of grooves 15I are uniformly distributed around the longitudinal axis X. Preferably, two adjacent grooves substantially form an angle of 90° degrees with the rotation axis.

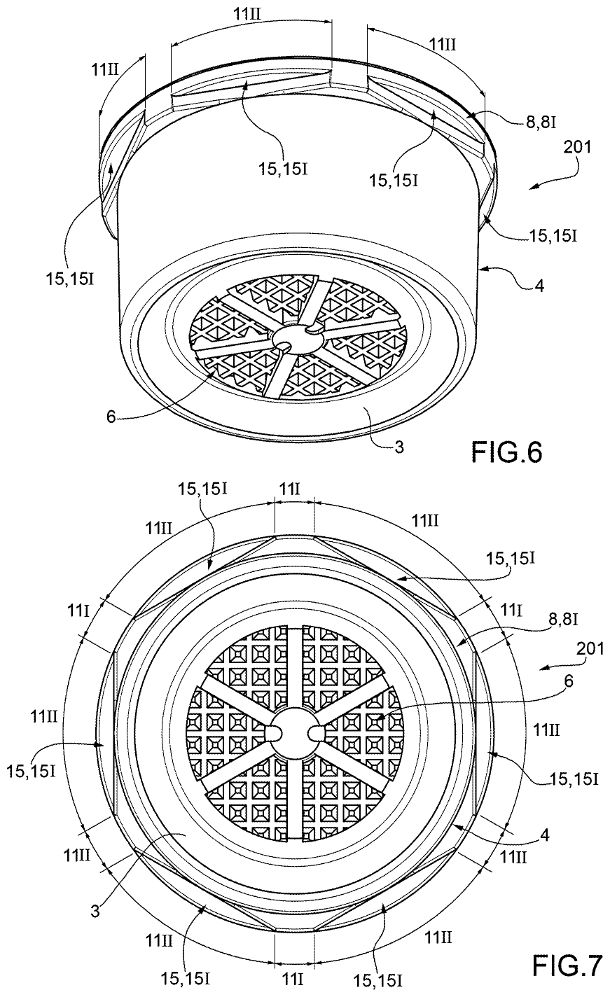

According to the example illustrated in FIGS. 5 and 6, the grooves 15I are six. In particular, the capsule 201 has three pairs of grooves 15I parallel and opposite to one another.

In the example illustrated, the pairs of grooves 15I are uniformly distributed around the longitudinal axis X.

Two adjacent grooves 15I form an angle of 60° with the rotation axis.

According to an alternative not illustrated, the collar 8I can have only one groove. The collar 8I can have a number of grooves 15I different from the illustrated examples. The collar 8I can have grooves 15I of different shapes and sizes. In other words, the collar 8I can have a plurality of different combinations with respect to those illustrated by number and/or shape and/or size of the grooves.

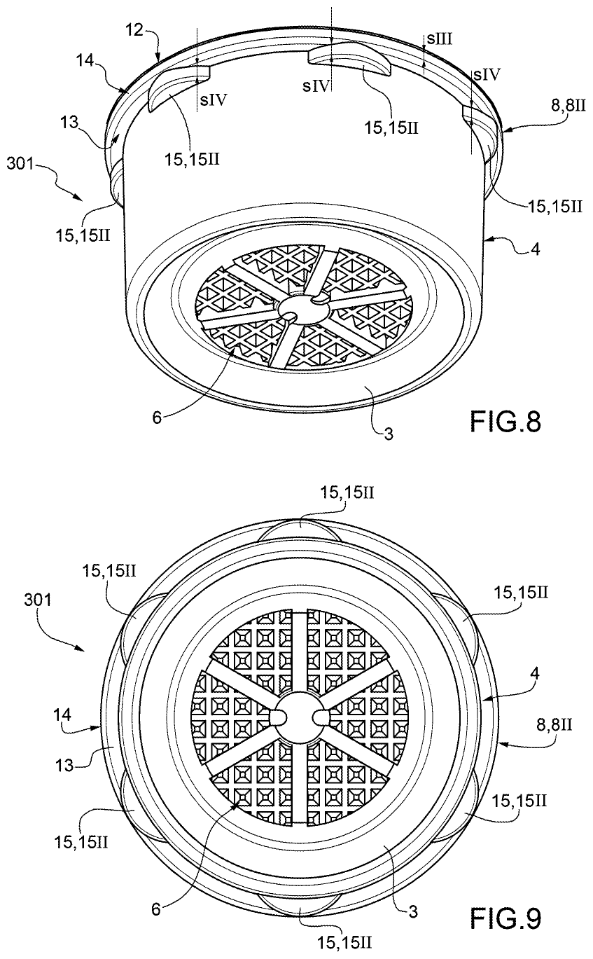

In FIGS. 8 to 11, examples of a further embodiment of a capsule according to the present invention are illustrated. The elements in common with the capsules described above maintain the same numbering and are considered included therein, without repeating them for brevity.

In particular, according to what is illustrated in FIGS. 8 to 11, the variation means 15 are protrusions 15II, that is, elements which locally increase the thickness of the capsule. Advantageously, the protrusions 15II are adjacent to or made in a single piece with the collar 8II. In this case, the collar 8II has a reduced thickness sIII compared to a traditional type collar 8II.

For example, the collar 8II has a thickness sIII comprised between 0.5 and 2 mm. In this case, the protrusions 15II compensate for the difference in thickness between the collar 8II with reduced thickness and the standard thickness of a traditional type capsule. The thickness sIV of a protrusion 15II is comprised between 1 and 5.5 mm.

In this way, the capsule 301 of the type described above can be used in a machine for preparing beverages without the risk of jamming or malfunctions.

According to the example illustrated in FIGS. 8 and 9, the protrusions 15II are six. The protrusions 15II are uniformly distributed around the longitudinal axis X of the capsule 1. The protrusions 15II protrude from the lower surface 13 of the collar 8II and protrude towards the bottom 3. The protrusions 15II have a curved shape with concavity facing towards the lateral wall 4 of the cup-shaped body 2. According to the example illustrated in FIGS. 8 and 9, each protrusion 15II is laterally limited by a curved edge 16. In this way, advantageously, the curved shape of the edge 16 helps the insertion/rotation of the capsule 301 during use, avoiding possible jamming.

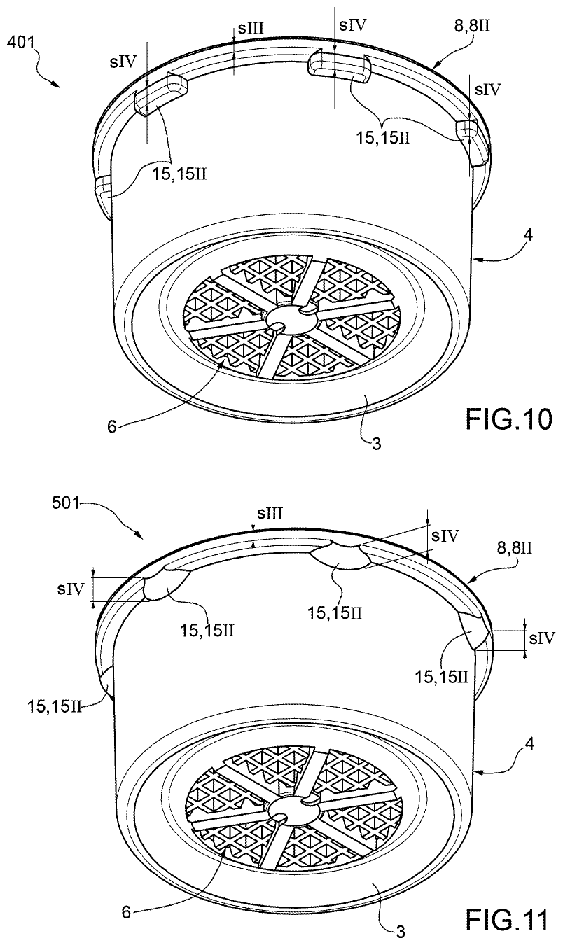

FIGS. 10 and 11 show possible alternatives of protrusions 15II. According to the example illustrated in FIG. 10, the capsule 401 has parallelepiped shaped protrusions 15II with a rectangular base. According to the example illustrated in FIG. 11, the capsule 501 has protrusions 15II with a spherical i.e. rounded profile.

According to alternatives not illustrated, the protrusions can vary in shape and/or number and/or size. According to alternatives not illustrated, the protrusions can be adjacent to or protrude from the upper surface 12 or alternatively protrude from the upper surface 12 and from the lower surface 13.

Advantageously, the capsules 1, 101, 201, according to the present invention, have portions 111 of the collar 8I with reduced thickness compared to the standard capsules.

While, the capsules 301, 401, 501 allow using a collar 8II with reduced thickness compared to the standard capsules compensating for the variation in thickness with the protrusions 15II arranged in proximity of the collar 8II or which are made in a single piece with the collar 8II.

The solutions described above allow to reduce the quantity of material, generally plastic, used for the production of each capsule 1. This multiplied by the large quantities of capsules produced/used involves a considerable reduction in the consumption of plastic, with consequent reduction of pollution/environmental impact.

Advantageously, the capsules 1, 101, 201, 301, 401, 501 of the type described above can also be used in pre-existing machines for preparing beverages, without the risk of jamming/malfunctions. In fact, the variation means 15 allow to maintain, at least in an area of the collar 8, 8I, 8II, a thickness substantially equal to the standard thickness of the capsules of a known type. In particular, the thicker area 11II, 15II of the collar 8 interacts with the machine for preparing beverages thus preventing malfunctions.

1. A capsule for infusion products comprising a cup-shaped body with a longitudinal axis, a bottom and a side wall, which delimit an inner chamber to house a product for infusion and an opening for putting said inner chamber in communication with the external environment; the cup-shaped body comprising a collar, which protrudes outside of said side wall at said opening; the capsule comprising a lid which is connected to said collar and closes said opening; the capsule being characterized by having a variable thickness in proximity of said collar.

2. A capsule according to claim 1, wherein the collar has an upper surface, a lower surface and a lateral surface; the capsule comprising one or more variation means, each of which is configured to locally vary the thickness of the collar or to cooperate with the collar in order to locally obtain a predefined thickness.

3. A capsule according to claim 2, wherein each variation means is a groove configured to locally reduce the thickness of the collar; wherein the thickness of the collar is the distance along the longitudinal axis between the upper surface and the lower surface.

4. A capsule according to claim 2, wherein the collar has one or more grooves each of which is made at a respective first portion; wherein the collar has one or more second portions adjacent to said first portions; wherein the thickness of said first portions is less than the thickness of said second portions.

5. A capsule according to claim 4, wherein the thickness of said first portions is comprised between 0.5 and 2 mm; wherein the thickness of said second portions is comprised between 3 e 6 mm.

6. A capsule according to claim 2, wherein each variation means is a protrusion; wherein each protrusion is adjacent to said lower surface or is made in a single piece with said collar.

7. A capsule according to claim 6, wherein each protrusion axially protrudes from said lower surface and/or from said upper surface.

8. A capsule according to claim 6, wherein the collar has a thickness comprised between 0.5 and 2 mm; wherein said protrusions have a thickness comprised between 1 and 5.5 mm.

9. A capsule according to claim 2 and comprising a plurality of variation means uniformly distributed about said longitudinal axis.
